(19) United States
(12) Patent Application Publication
(10) Pub. No.: US 2015/0081550 A1
(43) Pub. Date: Mar. 19, 2015

(54) REMOTE TRANSACTION PROCESSING USING BIOMETRICS

(71) Applicants: Seth Priebatsch, Boston, MA (US); Yonatan Samlan, Cambridge, MA (US)

(72) Inventors: Seth Priebatsch, Boston, MA (US); Yonatan Samlan, Cambridge, MA (US)

(73) Assignee: SCVNGR, Inc., Boston, MA (US)

(21) Appl. No.: 14/481,168

(22) Filed: Sep. 9, 2014

Related U.S. Application Data
(60) Provisional application No. 61/875,872, filed on Sep. 10, 2013.

(51) Int. Cl. G06Q 20/40

(52) U.S. Cl. CPC G06Q 20/40145
USPC 705/44

(57) ABSTRACT

In various embodiments, transactions among consumers, merchants, and transaction-processing entities are processed and authorized at least in part on the basis of biometric indicia obtained from the consumers.

### RELATED APPLICATION

This application claims the benefit of and priority to U.S. Provisional Patent Application No. 61/875,872, filed Sep. 10, 2013, the entire disclosure of which is hereby incorporated herein by reference.

### TECHNICAL FIELD

In various embodiments, the present invention relates to systems and methods for verifying the validity of payment transactions.

### BACKGROUND

It is common practice for consumers to pay a merchant electronically for goods or services received. Electronic payments are typically made with a token that identifies a source of funding. For example, a credit card containing a magnetic strip is a token. Payment tokens usually contain static information, such as an account number, identifying a source of payment. When a credit card is swiped, the card number is transmitted to a centralized payment-processing system. Before authorizing payment, the payment-processing system may verify whether the account exists and is active, whether the account can fund the transaction, or whether the transaction may be fraudulent. A physical token such as a credit card cannot be easily modified and, in the event that it is lost or stolen, the consumer must report the lost card and wait for a replacement to be mailed. As a result, systems that allow a consumer to pay for a transaction at the point of sale (POS), using a mobile device to display a token (usually in the form of a barcode or Quick Response (QR) code), are becoming widely accepted. Similar to credit-card tokens, mobile device tokens typically contain static information that must be transmitted to a centralized payment processing system for authentication and payment authorization.

Even these systems, however, require the consumer to present a physical item in order to provide payment. If the mobile device is inoperable or runs out of power, for example, the consumer will be unable complete the transaction. Accordingly, there is a need for payment techniques that do not rely on presentation of a physical token or device by the consumer to complete transactions.

### SUMMARY

Embodiments of the present invention address the abovementioned need by obtaining biometric indicia of the consumer, transmitting the indicia to a central server for authentication, and sending authorization to the point of sale to facilitate completion of the transaction. Advantageously, when the biometric indicia are obtained optically (e.g., by capturing an image of the consumer's face and/or nodal points of the face), the same imaging device can be used to scan a barcode or other identifier of the item(s) to be purchased. For example, the scanner may be a GOOGLE GLASS headset (available from Google Inc. of Mountain View, Calif.) or other head-mounted image-capture device, or simply a “smart phone” or other hand-held device with image-capture capability. The image-capture device may be programmed to recognize the presence, in its field of view, of a face; and upon face detection, programming directs the image-capture device to record an image and extract therefrom “faceprint” nodal points or other identifying indicia for transmission to a central server for analysis. Following detection of a face, the capture device may await an image of a barcode or other identifier of one or more items to be purchased (or, in some implementations, the item itself), and transmit this (or, in some embodiments, pricing information for the item and/or other purchase information related to the item), with or without information identifying the merchant, to the central server along with or following transmission of the biometric indicia. (The term “item” is herein used broadly to connote not only goods but services, food, entertainment, etc.) The server attempts to match the biometric data with a known individual and may retrieve product and price information from (or based on) the transmitted item identifier or item image, and using various criteria described in greater detail below, determines whether to authorize the transaction. If so, it may transmit a visual or audible message to the wearer or holder of the capture device, who may inform the consumer that the transaction has been completed or, in some embodiments, request a secondary action by the consumer (e.g., a smile or a thumbs-up gesture) indicating assent to the transaction and/or selection of a payment provider; in the latter case, successive captured images are analyzed locally or sent to the server for detection of the requested action. The server also sends an authorization to the merchant, and in some embodiments, that is the only communication the server provides; in these embodiments the merchant system sends the alert to the clerk operating the capture device.

Variations of this basic scheme are of course possible. Biometric indicia other than the user's face may be used alternatively or in addition—for example, the image-capture device may capture audio of the consumer's voice and/or the clerk's (or merchant's) voice. (This is readily implemented using a headset such as GOOGLE GLASS, which has both image and audio capture capability.) The audio capture mechanism may be used to capture information about products and/or services to be purchased, in place of or in addition to optically scanning the item or a code on the item. In addition, the division of the processing load between the biometric capture device and the server represents a design choice: the capture device may perform initial processing to extract biometric data in order to reduce the amount of information transmitted to the server, or if it is desired to trade communication bandwidth against processing power, the capture device may simply capture and send the entire image (e.g., in compressed form) to the server for analysis.

In an aspect, embodiments of the invention feature a method of processing a transaction among a consumer, a merchant, and a transaction-processing entity. A server receives (i) biometric indicia of the consumer and (ii) purchase data for an item to be purchased. Lookup of a subscriber record corresponding to the biometric indicia is caused in response to the receipt of the biometric indicia and purchase data. Upon successful lookup of the corresponding subscriber record, validation criteria are obtained, and a determination is made whether the validation criteria are satisfied based at least in part on the purchase data. If so, an acknowledgment authorizing the transaction is transmitted.

Embodiments of the invention may include one or more of the following in any of a variety of combinations. A scanner may be used to obtain the biometric indicia of the consumer. The acknowledgment may be transmitted to the scanner and/or to the merchant. The scanner may be a head-mounted scanner. The purchase data may be obtained with the scanner. At least a portion of the purchase data may be spoken by the consumer or the merchant. After the acknowledgment authorizing the transaction is transmitted, the scanner may be used to obtain a transaction confirmation from the consumer, and the transaction may be completed. The transaction confirmation may include or consist essentially of a gesture and/or a vocalization (e.g., by the consumer). The biometric indicia may include or consist essentially of a faceprint and/or a voiceprint (i.e., a voice sample sufficient to identify the consumer). The validation criteria may be obtained at least in part from the subscriber record. The validation criteria may be established at least in part by the merchant.

In another aspect, embodiments of the invention feature a system for processing a transaction among a consumer, a merchant and a transaction-processing entity. The system includes or consists essentially of a scanner for obtaining biometric indicia of the consumer, a transaction-processing server, and at least one database for storing biometric indicia, subscriber records, and validation criteria. The scanner is in communication with a point-of-sale system, and the transaction-processing server is in communication with the scanner via the point-of-sale system. The transaction-processing server is configured to (i) receive the biometric indicia and purchase data for an item to be purchased from the point-of-sale system and/or the scanner and, in response thereto, cause lookup in the at least one database of (a) a subscriber record corresponding to the biometric indicia and (b) validation criteria, (ii) determine whether the validation criteria are satisfied based at least in part on the purchase data, and (iii) if so, authorize the transaction and transmit an authorization acknowledgment.

Embodiments of the invention may include one or more of the following in any of a variety of combinations. The scanner may be a head-mounted scanner. The point-of-sale system may be configured to receive the purchase data from the scanner. The biometric indicia may include or consist essentially of faceprints and/or voiceprints. The subscriber records may contain at least a portion of the validation criteria. The validation criteria may be established at least in part by the merchant.

In yet another aspect, embodiments of the invention feature a method of processing a transaction among a consumer, a merchant, and a transaction-processing entity. Biometric indicia of the consumer are obtained using a scanner. The biometric indicia and purchase data for an item to be purchased are transmitted to a server. The biometric indicia and the purchase data are received by the server and, in response thereto, lookup of a subscriber record corresponding to the biometric indicia is caused. Validation criteria are obtained upon successful lookup of the corresponding subscriber record, and a determination is made whether the validation criteria are satisfied based at least in part on the purchase data. If so, an acknowledgment authorizing the transaction is transmitted.

Embodiments of the invention may include one or more of the following in any of a variety of combinations. The acknowledgment may be transmitted to the merchant and/or to the scanner. The biometric indicia may include or consist essentially of a faceprint and/or a voiceprint. The scanner may be a head-mounted scanner. The validation criteria may be obtained at least in part from the subscriber record. The validation criteria may be established at least in part by the merchant. The purchase data may be obtained with the scanner. At least a portion of the purchase data may be spoken by the consumer and/or the merchant. After the acknowledgment authorizing the transaction is transmitted, the scanner may be used to obtain a transaction confirmation from the consumer, and the transaction may be completed. The transaction confirmation may include or consist essentially of a gesture and/or a vocalization.

In another aspect, embodiments of the invention feature a system for processing a transaction among a consumer, a merchant and a transaction-processing entity. The system includes or consists essentially of a scanner for obtaining biometric indicia, a point-of-sale system in communication with the scanner, a transaction-processing server in communication with the point-of-sale system, and at least one database for storing biometric indicia, subscriber records, and validation criteria. The point-of-sale system is configured to (i) receive the biometric indicia from the scanner and (ii) transmit to the transaction-processing server (a) the biometric indicia and (b) purchase data for an item to be purchased. The transaction-processing server is configured to (i) receive the biometric indicia and purchase data from the point-of-sale system and, in response thereto, cause lookup in the at least one database of (a) a subscriber record corresponding to the biometric indicia and (b) validation criteria, (ii) determine whether the validation criteria are satisfied based at least in part on the purchase data, and (iii) if so, authorize the transaction and transmit an authorization acknowledgment.

Embodiments of the invention may include one or more of the following in any of a variety of combinations. The scanner may be a head-mounted scanner. The point-of-sale system may be configured to receive the purchase data from the scanner. The biometric indicia may include or consist essentially of faceprints and/or voiceprints. The subscriber records may contain at least a portion of the validation criteria. The validation criteria may be established at least in part by the merchant.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, the terms “approximately” and “substantially” mean±10%, and in some embodiments, ±5%. The term “consists essentially of” means excluding other materials that contribute to function, unless otherwise defined herein. Herein, the terms “customer,” “consumer,” and “subscriber” are utilized interchangeably unless otherwise indicated.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a block diagram of an exemplary network in accordance with various embodiments of the invention;

FIGS. 2A and 2B are block diagrams of an exemplary scanner and a transaction validation server, respectively, in accordance with various embodiments of the invention; and

FIG. 3 is a flowchart illustrating a method of processing transactions in accordance with various embodiments of the invention.

### DETAILED DESCRIPTION

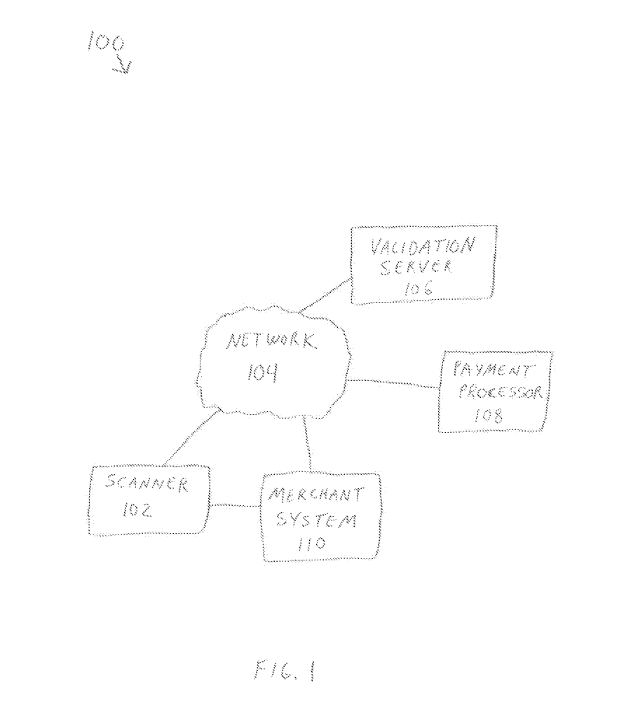

FIG. 1 depicts a mobile-payment transaction network 100 including a scanner 102 (e.g., an image- and/or audio-capture device, which may be head-mounted) linked to other systems via a network 104 that supports wired, wireless, or any two-way communication (e.g., a cellular telephone network, the Internet, or any wide-area network or combination of networks capable of supporting point-to-point data transfer and communication). The network 104 connects various devices, including a validation server 106, a payment processor 108, and one or more merchant systems 110, utilizing, again, wired, wireless, or any suitable form of two-way communication. Each merchant system 110 may be associated with a merchant who offers goods or services for sale to customers. In one embodiment, the merchant system 110 is a point-of-sale (POS) system (e.g., an electronic cash register) that connects to the scanner 102. The scanner 102 may be mobile or physically associated with the merchant system 110 (or the user thereof) and may be capable of acquiring and/or decoding biometric information of the customers and information identifying items the customer wishes to purchase. The scanner 102 may also capture images, audio, and/or video of consumer actions utilized to validate transactions, as described herein. The scanner 102 may include or consist essentially of, for example, a GOOGLE GLASS headset or other head-mounted image-capture device, or simply a mobile device with image-capture and/or audio-capture capability. As used herein, the term “mobile device” used for, e.g., acquiring biometric information, refers to a “smart phone” or tablet with advanced computing ability that, generally, facilitates bi-directional communication and data transfer using a mobile telecommunication network, and is capable of executing locally stored applications, biometric analysis, and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs).

Embodiments of the present invention may utilize a variety of different biometric indicia to facilitate consumer transactions. For example, the scanner 102 may be programmed to recognize the presence, in its field of view, of a face; and upon face detection, programming directs the scanner 102 to record an image and extract therefrom “faceprint” nodal points or other identifying indicia. In other embodiments, the scanner 102 captures and/or utilizes other types of biometric information instead of or in addition to facial recognition. For example, the scanner 102 may capture the voice of the customer and thus utilize a “voiceprint” for identification. The scanner 102 may even include or consist essentially of a fingerprint reader or retinal scanner to capture the unique features of the customer's fingerprint or retina pattern (i.e., the pattern of blood vessels disposed at the retina of the eye), although biometric identification techniques that do not rely upon contact with (or even extremely close proximity to) the customer are preferred. In addition, embodiments of the invention may utilize multiple different types of biometric information for verification purposes and/or additional security.

Various embodiments of the invention also utilize the same scanner 102 to acquire the biometric information of the customer and to acquire and transmit data identifying one or more items that the customer wishes to purchase. For example, the scanner 102 may capture an image of a barcode or other identifier (e.g., a QR code) of one or more items to be purchased (or, in some embodiments, the item itself). The scanner 102 may even be utilized to scan a radio-frequency identification (RFID) code of the item to be purchased. In other embodiments, the scanner 102 is utilized to capture the voice of the customer and/or a clerk (i.e., a representative of the merchant, or in some embodiments, the merchant himself or herself) utilizing the scanner 102 when the name (or other identifying information) of the item to be purchased is spoken by the customer or the clerk. The price of the item(s) to be purchased may also be acquired by the scanner 102 by, e.g., capturing the voice of the clerk when the price is spoken, or, once the item to be purchased has been identified, its current price may be obtained in, for example, a look-up table.

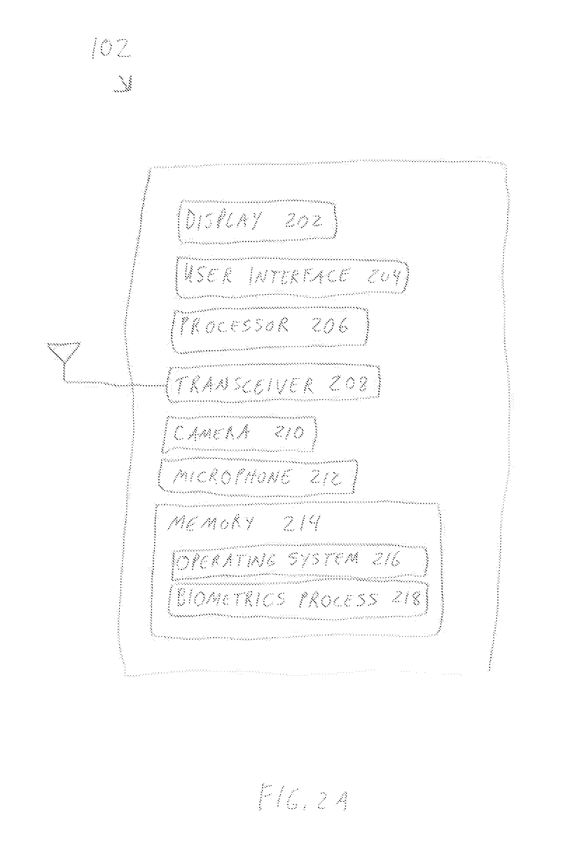

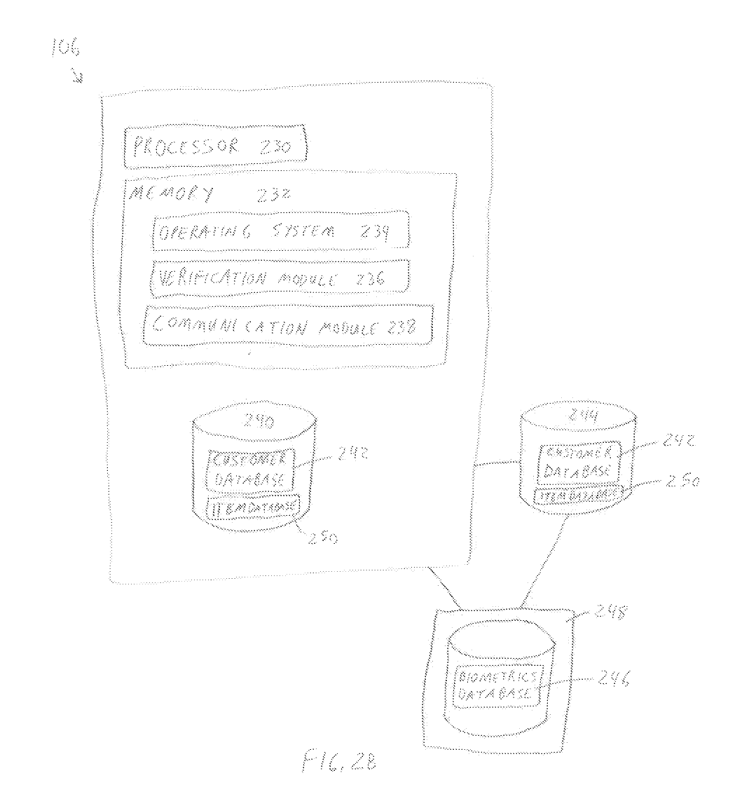

The scanner 102 can support multiple communication channels for exchanging multimedia and other data with the validation server 106, merchant system 110, and other devices using a Wi-Fi LAN (e.g., IEEE 802.11 standard) for Internet access, a short-range Bluetooth wireless connection for point-to-point access, and/or a near-field communication (NFC) channel for close-proximity access. Referring to FIG. 2A, in various embodiments, the scanner 102 includes a conventional display screen 202, a user interface 204, a processor 206, a transceiver 208, a camera 210, a microphone 212, and a memory 214. (In some embodiments, one or more of the aforementioned components is omitted, and/or the scanner 102 incorporates one or more additional components.) The transceiver 208 may be a conventional component (e.g., a network interface or transceiver) designed to provide communications with a network, such as the Internet and/or any other land-based or wireless telecommunications network or system, and, through the network, with the validation server 106 and/or the merchant system 110. The memory 214 includes an operating system (OS) 216, such as GOOGLE ANDROID, NOKIA SYMBIAN, BLACKBERRY RIM or MICROSOFT WINDOWS MOBILE, and a biometrics process 218 that implements the device-side functions for transmitting, receiving and/or analyzing the customer's biometric information. Additional transactional information may be embedded in the biometrics process 218 for transmission through the network 104 for later processing on a back-end server (e.g., the validation server 106). The memory 210 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit.

The merchant system 110 (or, in some embodiments, the scanner 102 itself) transmits the acquired biometric information and transaction details to the validation server 106 to verify the consumer's identity and, in some embodiments, determine validity of the transaction. If the customer's identity is verified, the validation server 106 may direct the payment request to the payment processor 108 for approval or, in some embodiments, grant the payment request. If the customer cannot be identified, the validation server 106 may interrupt the transaction and transmit a denial message to the merchant system 110. The payment processor 108 may be responsible for actually performing the payment transaction. For example, a so-called “direct” payment processor represents the financial-processing backend provider to credit-card issuers and payment services such as PAYPAL. An “indirect” payment processor is an independent entity processing transactions for multiple payment services and maintains its own records and data. In some embodiments, only one or more pieces of data relevant to the item to be purchased acquired or derived by the scanner 102 and/or the merchant system 110 are forwarded to the validation server 106. For example, in some embodiments only the pricing information for the item need be transmitted to the validation server 106, which evaluates and validates the transaction on the basis of the customer's identity and the price of the item (i.e., the amount of money to be spent). (In such embodiments, the other purchase data (e.g., the item type, brand, size, quantity, etc.) may be monitored and/or stored for, e.g., inventory purposes.) In other embodiments, as described below, purchase data other than, or in addition to, pricing identification is transmitted to the validation server 106, and the transaction is processed for verification based at least in part on the purchase data.

Referring to FIG. 2B, in some embodiments, the validation server 106 includes a processor 230, a memory 232 having an operating system (OS) 234, a verification module 236, a communication module 238 and a storage device 240. As shown, a customer database 242 resides in the storage device 240 and/or an external mass-storage device 244 accessible to the validation server 106. The communication module 238 may be a conventional component (e.g., a network interface or transceiver) designed to provide communications with a network, such as the Internet and/or any other land-based or wireless telecommunications network or system, and, through the network, with the scanner 102. The customer database 242 stores a record associated with each registered consumer and is responsive to queries from the verification module 236. The consumer's record typically includes (a) biometric information or a pointer thereto, (b) payment information, and (c) profile information about the customer. Biometric information may be, for example, faceprint nodal measurements and/or voiceprint information, but any biometric (or other scannable identifying) information may be used. As shown in FIG. 2B, in some embodiments of the invention the biometric information is stored in a separate biometrics database 246 (which may even be hosted on a separate biometrics server 248) for security purposes, and the customer database 242 contains pointers thereto. Thus, even if the validation server 106 is breached, the attacker will not necessarily gain access to the customer's biometric information. Payment information may specify one or more financial accounts of the customer, maintained at one or more financial institutions, to be charged when making authorized purchases. The customer profile information may include validation criteria utilized by the system to verify and complete payment transactions; for example, the validation criteria may include particular items, classes of items, and/or merchants for which biometrics-based transactions may be made.

The verification module 236 determines the identity of the consumer based on the biometric information acquired and/or analyzed by the scanner 102 by querying the customer database 242. In some embodiments of the invention, the biometric information is only captured by the scanner 102, and the raw data is passed to the verification module 236 for processing and identification of the customer; in other embodiments, the scanner 102 performs at least some of the analysis, and the wholly or partially processed biometric information is passed to the verification module 236 for customer identification. In various embodiments of the invention, the verification module 236 also verifies the validity of a transaction and detects fraudulent transactions in near real-time using transactional and non-transactional information about the consumer, as detailed, for example, in U.S. patent application Ser. No. 14/107,677, filed Dec. 16, 2013, the entire disclosure of which is incorporated by reference herein. Transactional data may be drawn from the consumer's records with a payment entity, while non-transactional data may arise from any of various sources—e.g., social media, preference information provided to or inferred by a merchant or a payment entity, or public or private databases.

In some embodiments, biometric information and/or information related to items to be purchased by consumers is utilized to generate and deliver promotions offered by the merchant (or another party) to the consumer, e.g., as described in U.S. patent application Ser. No. 14/189,482, filed Feb. 25, 2014, the entire disclosure of which is incorporated by reference herein. For example, the consumer's biometric data may be associated with transaction and other non-transactional data within a promotions database (which may be a part of database 242), and a promotion server may utilize such data, in conjunction with the item-specific data, to supply promotions or targeted advertising to the consumer.

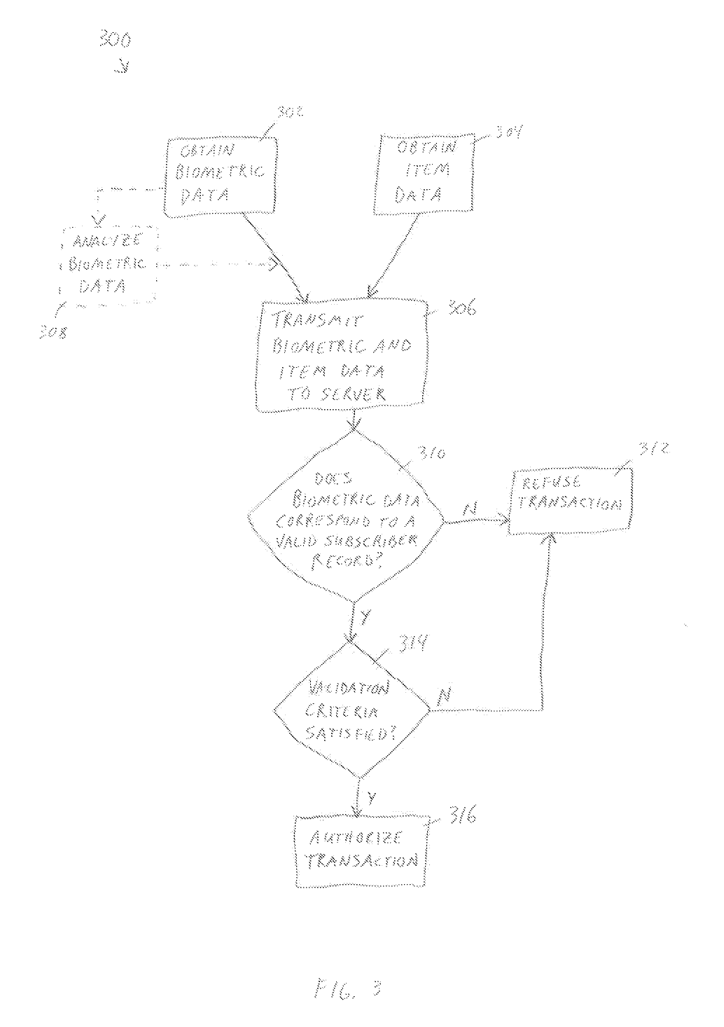

FIG. 3 is a flowchart depicting an exemplary method 300 of processing transactions in accordance with embodiments of the present invention. First, biometric data from a consumer is acquired (step 302), as is purchase data associated with an item to be purchased by the consumer (step 304). In various embodiments, both the biometric data and the purchase data associated with the item (e.g., one or more of the name and/or type of the item, size information, price information, brand information, identification of the merchant selling the item, etc.) are obtained by the same scanner. For example, the biometric data may be obtained via capturing and analyzing an image of the consumer's face and/or a sample of the consumer's voice, and the item information may be obtained via capture of an identifier (e.g., a barcode or QR code) or capture and analysis of an image of the item itself. The biometric and item data are then transferred to a server (e.g., validation server 106) from the scanner and/or the merchant system (step 306). In an optional step 308, the biometric data is at least partially analyzed by, e.g., the scanner and/or the merchant system before being transmitted to the server. For example, an image of the consumer's face may be analyzed to identify nodal points thereon that constitute a faceprint of the consumer; the faceprint itself may then be transmitted to the server. Once the data is received at the server (and analyzed at the server, in some embodiments), the server queries its database to identify a consumer record corresponding to the biometric data (step 310). If no corresponding record is found, the transaction is refused (step 312). Upon refusal of the transaction, the merchant may, for example, complete the requested transaction conventionally (i.e., without biometric identification and validation) and/or may create a new record in the database for the consumer based on the captured biometric data. If a record corresponding to the captured biometric data is found, then validation criteria are obtained from the consumer record and/or from the merchant (step 314). If the validation criteria are satisfied, then the transaction is authorized (step 316), and an acknowledgment may be transmitted to the merchant and/or to the scanner indicating the authorization. If the validation criteria are not satisfied (e.g., if the transaction, consumer, and/or item to be purchased do not qualify for validation via biometric analysis), then the transaction is refused and may be competed in a conventional fashion.

In a typical operation in accordance with various embodiments of the invention, a store clerk operating a scanner 102 (for example, wearing a head-mounted scanner 102) observes a customer (who may be standing in line at the store's exit) holding an item to be purchased. The clerk acquires an image of the customer's face (by, e.g., simply looking at the customer while wearing a heat-mounted scanner 102), triggering internal programming within the scanner 102 to obtain biometric indicia. For example, commonly deployed facial-recognition systems identify 80 nodal points on a human face. The nodal points are used to measure biometric variables associated with a face, such as the length or width of the nose, the depth of the eye sockets and the shape of the cheekbones. These nodes (or distances between groups of them) may be captured and stored as a faceprint.

The clerk then utilizes the scanner 102 to acquire the identification of the item to be purchased by the customer. For example, the clerk may, if utilizing a head-mounted scanner 102, simply look at the item to be purchased, and the scanner 102 captures an image thereof or of a barcode or other identifier (e.g., a QR code) thereon with camera 210. The scanner 102 may decode the image to obtain an alphanumeric code identifying the item and the price. In other embodiments, the scanner 102 identifies the item to be purchased by audio capture, via microphone 212, of the customer or the clerk speaking the name (and quantity, if applicable) of the item. The price of the item to be purchased may also be spoken by the clerk and captured by the microphone 212, or the price (if printed on the item) may be identified from an image of the item captured by the camera 210, or the validation server 106 and/or merchant system 110 may contain pricing information for items sold by the merchant. Audio captured by the microphone 212 may be transmitted, for example, as audio files to the validation server 106, which analyzes the files to identify the items and prices, or the audio may be processed, via conventional speech-recognition algorithms, by the scanner 102, and the resulting item identification information may itself be transmitted to the validation server 106.

The scanner 102 then transmits the biometric data and one or more pieces of purchase information (e.g., the item identifier (or image), price, etc.), with or without information identifying the merchant to the validation server 106 and/or the payment processor 108. This may occur directly (e.g., via cellular transmission) or via short-range wireless communication (e.g., via an IEEE 802.11 protocol) to the validation server 106 itself or via a local internet-connected device (such as a merchant's point-of-sale (POS) terminal, laptop or desktop computer, or even a tablet or other mobile device) in communication with the validation server 106 over the internet. In the case of a POS terminal, completion of the transaction may be registered thereon for merchant recordkeeping as well as signaled to the clerk. In some embodiments, the transaction is not completed until a secondary action, which may be requested by the clerk, is performed by the customer and detected (locally or via image, audio, and/or video analysis at the validation server 106). For example, the secondary action may be, e.g., a smile or a thumbs-up gesture indicating assent to the transaction.

The payment information stored in the customer database 242 may specify one or more financial accounts of the consumer, maintained at one or more financial institutions, to be charged when making authorized purchases. In some embodiments, the consumer indicates a payment preference to the clerk, and this selection is registered by the scanner 102 or by the validation server 106. For example, the customer may be asked to point to the left to pay with Visa or to the right to pay with American Express, and the gesture may be captured by the scanner 102 and the payment processed accordingly. Alternatively, the customer may be asked to speak the selection, which is recorded by the scanner 102 (via microphone 212). In either case, the selection may be guided by financial accounts on file in the customer's profile; that is, the clerk is alerted by the validation server 106 and/or merchant system 110 that, for a particular consumer, multiple valid payment modes (e.g., Visa and American Express) are available. The clerk will thereupon ask the customer to make a selection, e.g., via a gesture or by a vocal indication. Indeed, if the validation server 106 and/or merchant system 110 is configured to monitor the words spoken by the clerk, the clerk may entertainingly vary among customers the gestures requested for the different payment options, and the validation server 106 will recognize the choice presented to a particular customer, the selection the customer makes, and the payment option to which it corresponds; especially in situations where customers stand in annoyingly long lines, giving stores clerks the ability to lighten the mood with engaging interactions may meaningfully enhance the customer's shopping experience.

Upon fulfillment of validation criteria (stored within, e.g., the customer database 242 as mentioned above) as described below, the validation server 106 may submit the transaction to payment processor 108 for payment in a conventional fashion and send an acknowledgment to the merchant system 110 guaranteeing payment. A signal may also be transmitted to the clerk by the validation server 106, payment processor 108, or merchant system 110, and the clerk may thereupon acknowledge completion of the transaction to the customer.

The validation criteria may be partly established by the organization or company responsible for maintaining the validation server 106 as well as by customers themselves. For example, a customer record in the customer database 242 may contain a profile of the customer including various preferences; some of these may specify the types of transactions eligible for completion using biometric recognition. Customers may, for example, interact with the validation server 106 via a web interface to specify desired restrictions—certain categories of eligible transactions (e.g., movies but not store purchases) or items, an upper dollar limit on eligible transactions, a restricted list of merchants, etc. —which are stored in the customer's database record.

The validation server 106 will generally obtain at least price and/or stock keeping unit (SKU) information from the item-identifying data transmitted by the scanner 102. Again, the scanner 102 may decode a captured barcode (or other identifier, or even an image of the item itself) and send price and SKU information to the server 106, or it may send an image of the identifier or even of the item itself, in which case the server 106 processes the image (in the latter case by matching to entries in an item database 250, which may be local or remote, or even merchant-specific and queried by the server 106 via a portal maintained by the merchant). To handle item-level validation criteria, the server 106 will typically need more information than simply the item's SKU code and price. The customer database 242 may contain lists of item categories, for example, that customers may designate as permitted or forbidden using the scanner-based biometric system described herein. The server 106 associates an item's SKU with one of these categories in determining whether item-level validation criteria are satisfied.

In various embodiments of the invention, the system may be organized so that upon recognition of a face (or, e.g., a voice) within its field of view, the scanner 102 obtains biometric information and transmits it to the validation server 106, which reacts by searching the customer database 242 for a match. If one is found, the customer's database record is retrieved; if not, a signal is sent to the clerk (directly or via the merchant system 110), who is alerted that the transaction cannot be processed using the scanner 102. In this way, the customer may not even realize he/she has been scanned and “rejected” by the system and may proceed to checkout in the ordinary fashion.

Similarly, embodiments of the invention may be utilized to expedite commercial transactions when many customers are queued up to purchase an item. For example, many customers may be in a line at a coffee shop, and a clerk may utilize a hand-held or head-mounted scanner 102 to capture biometric data for each customer, as well as the customer's order (by, e.g., capturing the voice of the clerk or the customer or by capturing a gesture). The transaction may be validated by the validation server 106, and the customer's order may be prepared, by the time the customer reaches the merchant's POS terminal. The merchant system 110 may display a grid of customer faces (either captured directly by the scanner 102 or downloaded from the validation server 106 based on biometric information acquired by the scanner 102), their corresponding orders, and indications whether or not each transaction has been validated (i.e., the order paid for). The merchant system 110 may even download from validation server 106 and display additional customer information (e.g., name, time since last visit, birthday, etc.), enabling customized interactions between the clerk and each customer.

Upon retrieval of a record, the validation server 106 may process transaction input from the scanner 102 (including, e.g., at least the merchant information and item to be purchased) against global and subscriber-specific validation criteria to determine whether to authorize the transaction. If the criteria are fulfilled, the transaction is completed as set forth above.

In some embodiments of the present invention, biometric and item-specific information is obtained from consumers, and transactions authorized and completed, without the need for a clerk. For example, the merchant system 110 may be an automated kiosk, or even a vending machine, that incorporates the scanner 102 and interacts with customers via audio files and/or text and graphics generated on an integrated display. As described herein, consumers may select items and types of payment at the kiosk and have their biometric information captured by the scanner 102. The data is transmitted to the validation server 106 and, if the relevant validation criteria (if any) are met, the transaction is authorized and the item is supplied to the consumer.

Uses of the invention are not limited to traditional transactions. For example, a customer profile may include the customer's age. Personnel staffing the entrance to a bar and wearing a head-mounted scanner 102 may verify patrons' ages as they stand in the admission line simply by looking at their faces, one at a time, as they reach the head of the line; the validation server 106 may verify that the individual associated with a particular set of transmitted biometric indicia is over 21 years of age and so signal the staff member via the head-mounted scanner 102, visually and/or audibly. Accordingly, the term “merchant” is herein used broadly to include any establishment that receives payment for items sold, services provided, admission granted, edibles served, etc., an “item to be purchased” includes any type of item as described above as well as admission (which may not involve payment) to a restricted facility, and validation criteria may also be supplied by the merchant—in this case, the bar's proprietor who specifies that an authorization signal can be sent only if the customer is over 21.

Those skilled in the art will readily appreciate that all configurations described herein are meant to be exemplary and that the actual configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “user device,” “mobile,” “communication device,” and similar terminology, refer to a wireless device (e.g., cellular phone, smart phone, computer, PDA, set-top box, Internet Protocol Television (IPTV), electronic gaming device, printer, and so forth) utilized by a user of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The processors 206, 230 that execute commands and instructions may each be a general purpose computer, but may utilize any of a wide variety of other technologies including a special purpose computer, a microcomputer, minicomputer, mainframe computer, programmed microprocessor, micro-controller, peripheral integrated circuit element, a CSIC (customer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, code or process) include machine instructions for a programmable processor, and can be implemented in a high-level procedural and/or object-oriented programming language, and/or in assembly/machine language. Any suitable programming language may be used to implement without undue experimentation the functions described herein. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of systems and techniques of the invention. Rather, any number of different programming languages may be utilized as is necessary or desirable.

The storage devices 240, 244 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the UNIX operating system, the LINUX operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

The storage devices 240, 244 may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described herein. For example, various forms of the flows shown above may be used, with steps re-ordered, added, or removed. Accordingly, other implementations are within the scope of the claims.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of processing a transaction among a consumer, a merchant, and a transaction-processing entity, the method comprising:
receiving, by a server, (i) biometric indicia of the consumer and (ii) purchase data for an item to be purchased;
in response to receipt of the biometric indicia and purchase data, causing lookup of a subscriber record corresponding to the biometric indicia;
upon successful lookup of the corresponding subscriber record, obtaining validation criteria; and
determining whether the validation criteria are satisfied based at least in part on the purchase data, and if so, transmitting an acknowledgment authorizing the transaction.

2. The method of claim 1, further comprising using a scanner to obtain the biometric indicia of the consumer.

3. The method of claim 2, wherein the acknowledgment is transmitted to the scanner.

4. The method of claim 3, wherein the acknowledgment is also transmitted to the merchant.

5. The method of claim 2, wherein the scanner is a head-mounted scanner.

6. The method of claim 2, further comprising obtaining the purchase data with the scanner.

7. The method of claim 6, wherein at least a portion of the purchase data is spoken by the consumer or the merchant.

8. The method of claim 2, further comprising, after the acknowledgment authorizing the transaction is transmitted, (i) using the scanner to obtain a transaction confirmation from the consumer, and (ii) completing the transaction.

9. The method of claim 8, wherein the transaction confirmation comprises at least one of a gesture or a vocalization.

10. The method of claim 1, wherein the acknowledgment is transmitted to the merchant.

11. The method of claim 1, wherein the biometric indicia comprise a faceprint.

12. The method of claim 11, wherein the biometric indicia further comprise a voiceprint.

13. The method of claim 1, wherein the biometric indicia comprise a voiceprint.

14. The method of claim 1, wherein the validation criteria are obtained at least in part from the subscriber record.

15. The method of claim 1, wherein the validation criteria are established at least in part by the merchant.

16. A system for processing a transaction among a consumer, a merchant and a transaction-processing entity, the system comprising:
a scanner, in communication with a point-of-sale system, for obtaining biometric indicia of the consumer;
a transaction-processing server in communication with the scanner via the point-of-sale system; and
at least one database for storing biometric indicia, subscriber records, and validation criteria,
wherein the transaction-processing server is configured to (i) receive the biometric indicia and purchase data for an item to be purchased from at least one of the point-of-sale system or the scanner and, in response thereto, cause lookup in the at least one database of (a) a subscriber record corresponding to the biometric indicia and (b) validation criteria, (ii) determine whether the validation criteria are satisfied based at least in part on the purchase data, and (iii) if so, authorize the transaction and transmit an authorization acknowledgment.

17. The system of claim 16, wherein the scanner is a head-mounted scanner.

18. The system of claim 16, wherein the point-of-sale system is configured to receive the purchase data from the scanner.

19. The system of claim 16, wherein the biometric indicia comprises at least one of faceprints or voiceprints.

20. The system of claim 16, wherein the subscriber records contain at least a portion of the validation criteria.

21. The system of claim 16, wherein the validation criteria are established at least in part by the merchant.
